(19) United States
(12) Patent Application Publication
(10) Pub. No.: US 2005/0281508 A1
(43) Pub. Date: Dec. 22, 2005

(54) System and method for introducing pump radiation into high-power fiber laser and amplifier

(75) Inventors: Vladimir Krupkin, Rishon Lezion (IL); Ehud Shafir, Rishon Lezion (IL)

Correspondence Address: DARBY & DARBY P.C., P. O. BOX 5257, NEW YORK, NY, 10150-5257, US

(73) Assignee: ELOP ELECTRO-OPTICS INDUSTRIES LTD., Rehovot (IL)

(21) Appl. No.: 10/980,982

(22) Filed: Nov. 3, 2004

Related U.S. Application Data
(63) Continuation of application No. PCT/IL03/00332, filed on Apr. 24, 2003.
(60) Provisional application No. 60/379,149, filed on May 8, 2002.

(51) Int. Cl. G02B 6/34; H01S 3/00

(52) U.S. Cl. 385/36; 372/6; 359/341.3

(57) ABSTRACT

Light amplifier including an active optical fiber, arranged such that a plurality of fiber sections thereof are aligned and closely packed along a substantially flat plane, thereby defining a light pumping region, and a light introducer having an entry surface and a substantially flat exit surface, the substantially flat exit surface being coupled with the light pumping region, wherein the light enters the active fiber at the light pumping region, through the light introducer, and wherein the device amplifies the light by exciting the active constituents of the active optical fiber.

### FIELD OF THE DISCLOSED TECHNIQUE

The disclosed technique relates to fiber lasers and amplifiers in general, and to methods and systems for introducing high-power pump light into an optical fiber, in particular.

### BACKGROUND OF THE DISCLOSED TECHNIQUE

A laser is a device which produces a highly directional coherent high intensity light beam (i.e., laser radiation) at a specific wavelength, by repeatedly amplifying a light beam. Laser radiation can be produced inside an optical fiber by pumping light into the fiber, wherein the core of the fiber is doped with constituents which emit laser radiation when excited by light at a certain wavelength. Generally, diode laser stacks are employed as a pump light source, in order to generate relatively high power laser radiation by the fiber. In order to efficiently introduce the power from the diode laser stack into the fiber, double-clad fibers are to be employed, wherein besides the core there exist two layers of cladding, an inner cladding where the pump light propagates and an additional outer cladding. Also, when significantly high-powers are to be emitted by the fiber, the pump light may be introduced at a multiple of predetermined regions along the length of the fiber. The distance between every two such consecutive predetermined regions is of the order of the length along which the power of light is absorbed by a certain amount (i.e., the absorption length).

U.S. Pat. No. 4,815,079 issued to Snitzer et al., and entitled “Optical Fiber Lasers and Amplifiers”, is directed to a structure for an optical fiber laser, which allows the multi-mode radiation of a cladding to be coupled to a single-mode core. The optical fiber laser includes the single-mode core surrounded by a first multimode cladding layer, a second cladding layer surrounding the first cladding layer and a third cladding layer which surrounds the second cladding layer. The cross section of the optical fiber laser is such that the center of the single-mode core is located away from the center of the first cladding. The index of refraction of the first cladding is lower than that of the single-mode core, and the index of refraction of the second cladding is lower than that of the first cladding.

Light is pumped into the optical fiber laser, from a laser diode pump source, either through an end of the optical fiber laser or through a side thereof. The ratio of the diameter of the first cladding and the single-mode core is such that most of the radiation of the light entering the optical fiber laser, is coupled into the first cladding, opposed to the radiation being directly coupled with the single-mode core. By displacing the center of the single-mode core from the center of the first cladding, the efficiency of side pumping of the single-mode is increased, because the skew rays are more readily absorbed.

U.S. Pat. No. 6,317,537 issued to Ionov et al., and entitled “Launch Port for Pumping Fiber Lasers and Amplifiers”, is directed to an apparatus and a method for pumping light into a convex section of a coiled double-clad fiber. The apparatus includes a first diode stripe, a second diode stripe, a first lens, a second lens, a launch port and a support block. The launch port includes a first pump light entry face and a second pump light entry face. The launch port is shaped to match the contour of the convex side of the fibers and the support block is shaped to match the contour of the concave side of the fibers. The outer cladding of a plurality of sections of the coiled fiber is stripped off at a location on the convex side of the coiled fiber, thereby exposing the inner cladding of each of the fiber sections.

The convex side of the support block is placed tightly adjacent the inner claddings, wherein the inner claddings form into a convex contour. The concave side of the launch port is tightly placed adjacent the convex side of the inner claddings. The first lens is located between the first pump light entry face and the first diode stripe. The second lens is located between the second pump light entry face and the second diode stripe. The first lens directs light from the first diode stripe to the inner claddings through the first pump light entry face and the second lens directs light from the second diode stripe to the inner claddings through the second pump light entry face.

U.S. Pat. No. 6,263,003 issued to Huang et al., and entitled “High-Power Cladding-Pumped Broadband Fiber Source and Amplifier”, is directed to a system for amplifying light. The system includes a laser diode array, a collimating lens, a dichroic reflector, a focusing lens, a fiber, an attenuator and an optical isolator. The collimating lens is located between the laser diode array and the dichroic reflector. The dichroic reflector is located between the focusing lens and the collimating lens. The fiber is located between the focusing lens and the attenuator. The attenuator is located between the fiber and the optical isolator.

The collimating lens directs light at 980 nm from the laser diode array to the dichroic reflector. The dichroic reflector transmits light at 980 nm wavelength to the focusing lens and the dichroic reflector reflects light at other wavelengths (such as 1550 nm). The focusing lens focuses light at 980 nm wavelength to first end of the fiber. Light at 980 nm wavelength repeatedly passes through the core of the fiber and the erbium ions of the fiber emit light at 1550 nm wavelength. Hence, light at 1550 nm wavelength emerges from the first end and a second end of the fiber.

The attenuator attenuates light having a wavelength of 980 nm and passes light having a wavelength of 1550 nm to the optical isolator. The optical isolator passes light at 1550 nm wavelength and prevents light at 1550 nm to travel back to the fiber. Light can be pumped into the cladding of the fiber, from a side thereof and through a prism. Due to internal reflections from the boundary of the cladding, the pumped light is confined.

U.S. Pat. No. 6,243,515 issued to Heflinger et al., and entitled “Apparatus for Optically Pumping an Optical Fiber from the Side”, employs a grating to Bragg diffract a pump light beam at an angle which matches the propagation mode of the optical fiber. The grating is provided with a periodic saw-tooth shape, which in turn provides a blazed corrugated relief pattern. A section of the coating of a multimode optical fiber is stripped off, thereby exposing the cladding, that may be the inner cladding of a double-clad active fiber, or may be a simple multimode fiber connected to an active double-clad fiber. A pump light beam originating from the laser pump source enters the multimode fiber and reaches the grating. The grating period is selected such that the diffraction angle matches the propagation mode of the multimode fiber and the blazed corrugated relief pattern is optimized for most efficient diffraction of the pump light beam.

U.S. Pat. No. 5,923,694 issued to Culver and entitled “Wedge Side Pumping for Fiber Laser at Plurality of Turns”, is directed to a system for pumping light into a wound pack of an optical fiber, from the side of the wound pack. The system includes the wound pack, a wedge, a lens element and a pumping laser. The wound pack includes a plurality of turns and can be wound in a plurality of layers. The optical fiber includes a core, a cladding which surrounds the core and a porous glass matrix layer which surrounds the cladding. The wedge is in the form of a cylinder with a triangular cross section, when a circular fiber is used. The wedge may have a simpler shape, when a rectangular fiber is used.

The wedge is located adjacent to a side of the wound pack in a lasing region of the wound pack. The lens element is located between the wedge and the pumping laser. Light is introduced into the optical fiber from the pumping laser, through the lens element and the wedge. The light is introduced in such a manner that it is trapped within the cladding and so that the recirculating pump light does not escape. Additional sets of wedges, lens elements and pumping lasers can be employed to introduce light at a plurality of lasing regions of the wound pack.

International Publication No. WO 00/54377 entitled “Side-Pumped Fiber Laser” is directed to a system for pumping light into an optical fiber from a side thereof. The system includes the optical fiber, a laser light source and a coupling window. The coupling window is shaped in a rectangular or a triangular form. The optical fiber includes a core and a cladding which surrounds the core. The index of refraction of the coupling window is greater than that of the core and the index of refraction of the core is greater than that of the cladding. A window channel is formed in the upper side of the cladding, by removing cladding material from the optical fiber, to a depth which exposes the core. The coupling window is located in the window channel.

Light which enters the optical fiber, from the laser light source through the coupling window, is trapped within the interior of the optical fiber and will eventually couple into the core, along the longitudinal extent of the optical fiber. The coupling window can be repeated along the length of the optical fiber, so that light is introduced into the optical fiber from a plurality of laser light sources, at different regions of the optical fiber.

U.S. Pat. No. 5,854,865 issued to Goldberg and entitled “Method and Apparatus for Side Pumping an Optical Fiber”, is directed to an apparatus for pumping light into an optical fiber from a side thereof, through a groove formed on a side of the optical fiber. The apparatus includes the optical fiber and a laser light source. The optical fiber includes an inner core, an outer core which surrounds the inner core and an outer cladding which surrounds the outer core. The index of refraction of the inner core is the highest and that of the outer cladding is the lowest. The groove is formed in the outer core and the outer cladding. The laser light source is located on the side of the optical fiber opposite the groove.

Light from the laser light source enters the optical fiber through the outer cladding and the outer core, and strikes the facets of the groove. The groove is formed such that the light which strikes the facets, undergoes specular reflection and is maximally reflected within the outer core. If the inner core contains active constituents, then the light which propagates within the outer core, activates the active constituents, thereby allowing the optical fiber to operate as an amplifier. A plurality of grooves can be formed at appropriate locations on the optical fiber and light can enter the optical fiber through each of these grooves.

### SUMMARY OF THE DISCLOSED TECHNIQUE

It is an object of the disclosed technique to provide a novel method and system for amplifying light. In accordance with the present invention, there is thus provided a device for amplifying light. The device including an active optical fiber and a light introducer. The optical fiber is arranged such that a plurality of sections thereof are aligned and closely packed along a substantially flat plane, thereby defining a light pumping region. The light introducer has an entry surface and a substantially flat exit surface. The substantially flat exit surface is coupled with the light pumping region, wherein the light enters the active fiber at the light pumping region, through the light introducer. The device amplifies the light by repeatedly exciting the active constituents of a core of the active optical fiber. If reflectors are placed at the ends of the active optical fiber or external to these ends, the device is operative to produce laser radiation.

In accordance with another aspect of the disclosed technique, there is thus provided a method for amplifying light. The method includes the procedures of linearly aligning a plurality of sections of an active optical fiber, side by side, along a substantially flat plane, placing a flat surface of a light introducer adjacent to the sections, repeatedly reflecting light within the active optical fiber, and amplifying the light within the active optical fiber. Laser radiation can be produced, by placing reflectors at the ends or external to the ends of the active optical fiber.

### BRIEF DESCRIPTION OF THE DRAWINGS

The disclosed technique will be understood and appreciated more fully from the following detailed description taken in conjunction with the drawings in which:

FIG. 1A is a schematic illustration of a section of a light amplifier, constructed and operative in accordance with an embodiment of the disclosed technique;

FIG. 1B is a schematic illustration of the cross section of an active optical fiber of the light amplifier of FIG. 1A;

FIG. 2A is a schematic illustration of a light amplifier, constructed and operative in accordance with another embodiment of the disclosed technique;

FIG. 2B is a schematic illustration of a top view of a light amplifier, which is similar to the light amplifier of FIG. 2A;

FIG. 3A is a schematic illustration of a light amplifier, constructed and operative in accordance with a further embodiment of the disclosed technique;

FIG. 3B is a schematic illustration of a top view of a light amplifier, which is similar to the light amplifier of FIG. 3A;

FIG. 4 is a schematic illustration of a light focusing assembly, constructed and operative in accordance with another embodiment of the disclosed technique;

FIG. 5 is a schematic illustration of a section of a light amplifier, constructed and operative in accordance with a further embodiment of the disclosed technique;

FIG. 6 is a schematic illustration of a top view of a light focusing assembly, constructed and operative in accordance with another embodiment of the disclosed technique;

FIG. 7 is a schematic illustration of a light amplifier, constructed and operative in accordance with a further embodiment of the disclosed technique; and

FIG. 8 is a schematic illustration of a method for operating the light amplifier of FIGS. 1A, operative in accordance with another embodiment of the disclosed technique.

### DETAILED DESCRIPTION OF THE EMBODIMENTS

The disclosed technique overcomes the disadvantages of the prior art by providing a light amplifier, which includes a flat facet prism, attached to a plurality of portions of an active optical fiber.

The term “critical angle” θ_{c} herein below, is defined as

$${θ}_{c} = {Sin}^{- 1} ( \frac{{n}_{1}}{{n}_{0}} ) \qquad ( 1 )$$

where n₀ is the index of refraction of the cladding of an optical fiber and n₁ is the index of refraction of the material which surrounds the cladding, such as air, vacuum, an outer cladding, and the like. Only a light beam whose angle relative to the normal to the boundary of the cladding, is greater than the critical angle, is totally reflected from the inner boundary of the cladding.

The term “active optical fiber” herein below, refers to an optical fiber whose core is doped with ions of a selected chemical element (i.e., an active constituent), such as erbium, ytterbium, and the like, which may amplify light at specific wavelengths, when excited by light. In a double-clad fiber, the core is surrounded by an inner cladding, which is further surrounded by an outer cladding. The term “total internal reflection” (TIR) herein below, refers to reflection of light between the sides of the inner cladding, where the outer cladding is stripped off and the inner cladding is surrounded by a substance whose index of refraction is lower than that of the inner cladding, such as air, vacuum, nitrogen and the like. Some of the reflected light enters the core, thereby exciting the ions which in turn amplify light at a specific wavelength.

The term “light pumping region” herein below, refers to a region of the active optical fiber where different sections thereof are aligned and closely packed along a substantially flat plane. The terms “pump light” and “pump light beam” herein below, refer to light which is introduced into the active optical fiber in order to amplify a light signal.

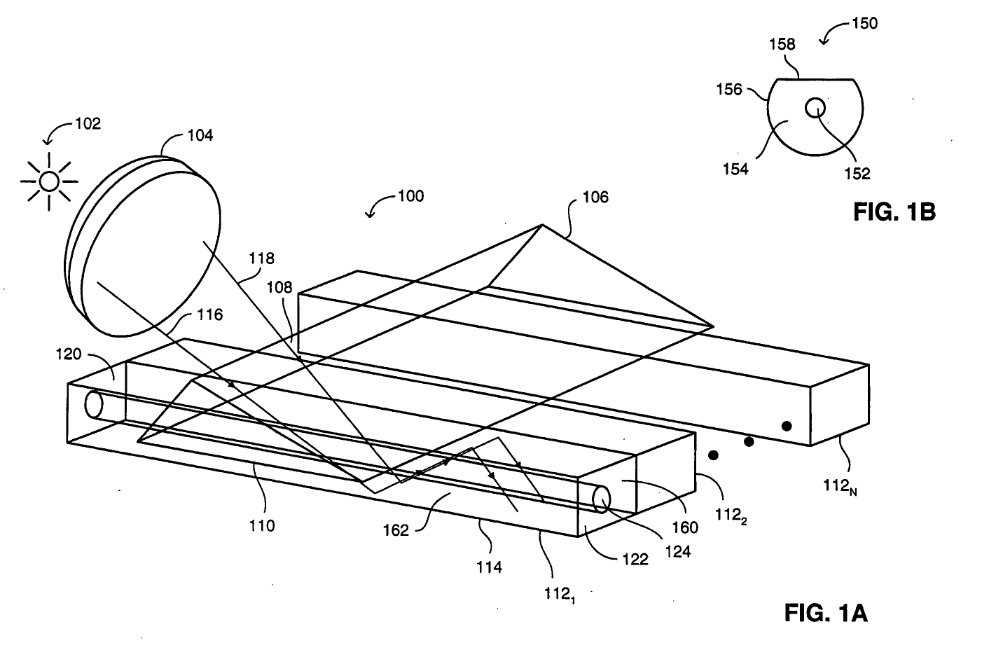

Reference is now made to FIGS. 1A and 1B. FIG. 1A is a schematic illustration of a section of a light amplifier, generally referenced 100, constructed and operative in accordance with an embodiment of the disclosed technique. FIG. 1B is a schematic illustration of the cross section of an active optical fiber of the light amplifier of FIG. 1A, generally referenced 150.

Light amplifier 100 includes a light source 102, an optical assembly 104, a light introducer 106 and a plurality of active optical fibers 112₁, 112₂ and 112_{N}. Light source 102 includes a plurality of laser diode stripes, which may be in the form of a stack which includes a plurality of stripes. Active optical fibers 112₁, 112₂ and 112_{N} are substantially identical, and thus, the following description relates only to active optical fiber 112₁, which is applicable also to active optical fibers 112₂ and 112_{N}.

Active optical fiber 112₁ includes a core 124, an inner cladding 114 which surrounds core 124, an outer cladding (not shown), which surrounds inner cladding 114 and a protective jacket (not shown), which surrounds the outer cladding. Light introducer 106 can be in the form of a prism whose cross section is triangular, trapezoidal, and the like. Light introducer 106 is made of an optically transparent material, such as glass, and the like. The refractive index of light introducer 106 is substantially equal to the refractive index of the inner cladding 114 of active optical fiber 112₁. Light introducer 106 includes an entry surface 108 and an exit surface 110. The optical power of entry surface 108 can be either zero (i.e., by being for example substantially flat) or non-zero (e.g., by having a curvature, such as concave, convex, and the like). Exit surface 110 is substantially flat. Active optical fibers 112₁, 112₂ and 112_{N} are aligned side by side and closely packed, along a substantially flat plane defining the light pumping region, to which exit surface 110 is attached.

Optical assembly 104 can include a lens, a plurality of lenses, other optical elements, and the like. Optical assembly 104 is located between light source 102 and entry surface 108. Inner cladding 114 is located adjacent to exit surface 110. The cross section of inner cladding 114 is substantially rectangular or square. Alternatively, the cross section of the inner cladding is a shape which includes at least one linear segment, oriented toward exit surface 110. Optical assembly 104 directs light beams originating from the light source 102 toward light introducer 106. The light beams which originate from light source 102, are represented by pump light beams 116 and 118.

The following description relates to the process of introducing light into active optical fiber 112₁ and the repeated reflections of this light within active optical fiber 112₁. This process is known in the art and is included herein, to complete the description of the disclosed technique. Optical assembly 104 directs light beams 116 and 118 in a direction which is substantially perpendicular to entry surface 108. Since the refractive indices of light introducer 106 and of inner cladding 114 are substantially equal, light beams 116 and 118 pass through a top surface 120 of inner cladding 114 without being substantially refracted.

Light beams 116 and 118 enter inner cladding 114 and strike a bottom surface 122 of cladding 114. Since the index of refraction of the medium (e.g., air or vacuum) in contact with bottom surface 122 is substantially less than the index of refraction of cladding 114, light beams 116 and 118 reflect from bottom surface 122. The index of refraction of the medium in contact with top surface 120 in regions other than the region in contact with light introducer 106, is substantially less than the refractive index of cladding 114. As a result, top surface 120 reflects the reflection of light beams 116 and 118 from bottom surface 122, thereby providing total internal reflection. Total internal reflection takes place, provided the angle between the direction of light beams 116 and 118 and the normal to the longitudinal axis of active optical fiber 112₁ is greater than the appropriate critical angles. In this manner, light beams 116 and 118 are repeatedly totally reflected from bottom surface 122, top surface 120, and side surfaces 160 and 162, while at each time having a certain probability of passing through core 124 of active optical fiber 112₁. At every pass through core 124, light beams 116 and 118 excite the ions (such as erbium, ytterbium, and the like) that are doped into core 124, wherein these ions amplify the signal light by the known process of stimulated emission.

As light beams 116 and 118 repeatedly totally reflect off the edges of inner cladding 114 and advance through active optical fiber 112₁, the power of the light beams 116 and 118 decays. The length along active optical fiber 112₁ at which the power of the emitted light beams decays by a certain amount is herein below referred to as “absorption length”. The absorption length depends on the wavelength of light beams 116 and 118, the materials composing the core and the inner structure thereof, the geometry of the core and the inner cladding, and the like.

It is noted that in general, the optical assembly concentrates the pump light beams so that they are substantially confined within the inner cladding, and are directed such that the total internal reflection conditions in the inner cladding are fulfilled. The diameter-angle product is defined as S=dₛₚₒₜ×θₘₐₓ is constant, wherein dₛₚₒₜ is the spot diameter, and θₘₐₓ is the maximum angle between the light beams and the optical axis. It is known in the art that for a collection of light beams traveling along an optical axis, the diameter-angle product S is substantially constant, even when the light beams undergo various reflections and refractions.

In a light amplifier such as light amplifier 100 (FIG. 1A), the pump light beams are guided by the inner cladding. Hence, at the plane perpendicular to the fiber axis, the diameter-angle product is limited by P=d×NA×n, wherein d is the lateral dimension of the inner cladding, NA is the sine of the maximum angle between the direction of propagation of the pump light beams and the longitudinal axis of the inner cladding, and n is the refractive index of the inner cladding. Accordingly, at the origin of the light beams (i.e., at the laser diode stripes), the condition S≦P should hold. It is noted that this condition directly dictates the maximum number of laser diode stripes, whose light beams may be concentrated into the inner cladding and guided thereby. This condition also dictates the maximum number of inner claddings to which the pump light beams may be concentrated.

A light amplifier such as light amplifier 100 may be incorporated in a laser cavity, by providing an apparatus for repeatedly passing light through the amplifier. Accordingly, pump light is introduced into the light amplifier, thereby producing and amplifying a light signal. This light signal is amplified, the amplified signal returns to the amplifier and is further amplified, and so forth. Thus, the signal is repeatedly amplified, thereby producing laser light.

For example, the laser cavity may be a linear laser cavity. Accordingly, a reflector is placed at each end of the optical fiber, whereby light repeatedly reflects from one reflector to another, each time passing through the light amplifier and thus being further amplified. Alternatively, the light amplifier may be incorporated in a laser ring cavity. Accordingly, light repeatedly travels through the laser ring, each time passing through the light amplifier and thus being further amplified.

With reference to FIG. 1B, active optical fiber 150 includes a core 152 and an inner cladding 154. The cross section of inner cladding 154 is confined by a sector 156 of a circle (not shown) and a chord 158 of this circle (i.e., D-shape). A light introducer similar to light introducer 106 is placed adjacent to active optical fiber 150, such that a surface (not shown) of inner cladding 154, defined by chord 158 and a length (not shown) of inner cladding 154, makes contact with an exit surface of the light introducer, similar to exit surface 110.

According to one aspect of the disclosed technique, an active optical fiber is wound in a plurality of coils having a mutual longitudinal axis and wherein each coil is located within another coil having a larger diameter. The active optical fiber is wound such that the height of all the coils are substantially equal and that the outer annular faces of all the coils are located on the same plane. The flat surface of a light introducer is placed at this plane adjacent the outer annular faces and light is pumped into the active optical fiber, from a light source through an optical assembly and the light introducer.

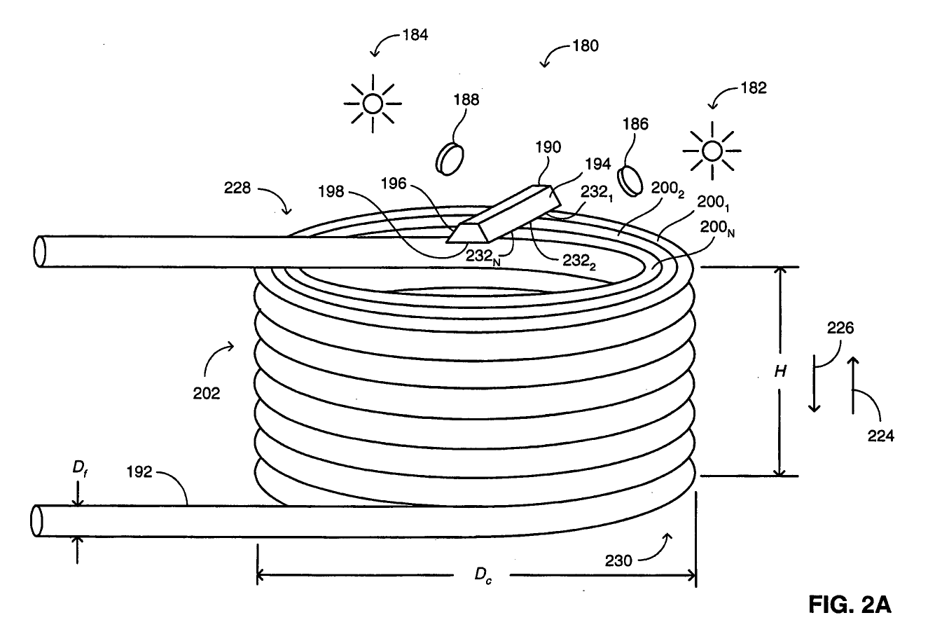

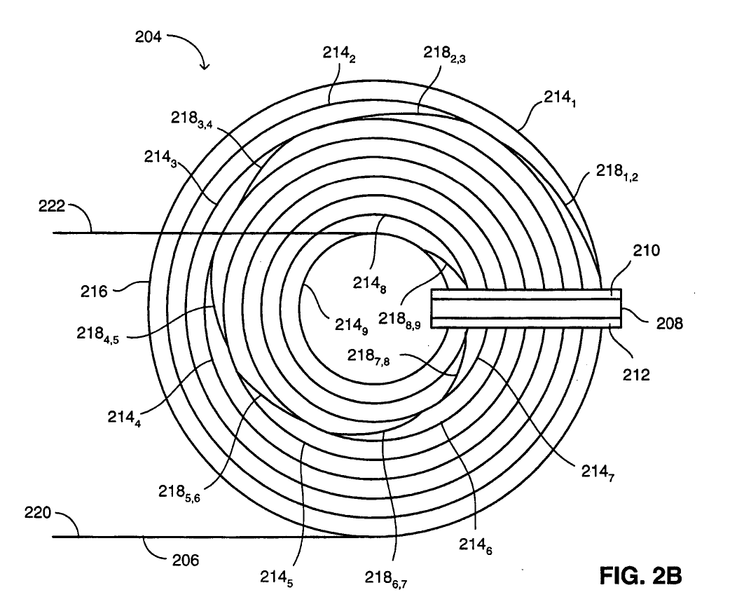

Reference is now made to FIGS. 2A and 2B. FIG. 2A is a schematic illustration of a light amplifier, generally referenced 180, constructed and operative in accordance with another embodiment of the disclosed technique. FIG. 2B is a schematic illustration of a top view of a light amplifier, generally referenced 204, which is similar to the light amplifier of FIG. 2A.

With reference to FIG. 2A, light amplifier 180 includes light sources 182 and 184, optical assemblies 186 and 188, a light introducer 190 and an active optical fiber 192. Light introducer 190 includes entry surfaces 194 and 196 and an exit surface 198. Active optical fiber 192 is wound in a plurality of coils 200₁, 200₂ and 200_{N}, thereby forming a coiled structure 202, where N is a positive integer. Each of light sources 182 and 184 is similar to light source 102 (FIG. 1A). Each of optical assemblies 186 and 188 is similar to optical assembly 104. Active optical fiber 192 is similar to each of active optical fibers 112₁, 112₂ and 112_{N}.

The manner in which coils 200₁, 200₂ and 200_{N} of active optical fiber 192 are wound, is described herein below with reference to an active optical fiber 206 of light amplifier 204 of FIG. 2B. Light amplifier 204 includes active optical fiber 206 and a light introducer 208. Light introducer 208 includes entry surfaces 210 and 212 and an exit surface (not shown). Light introducer 208 is similar to light introducer 190 (FIG. 2A).

Active optical fiber 206 is wound in a plurality of coils 214₁, 214₂, 214₃, 214₄, 214₅, 214₆, 214₇, 214₈ and 214₉, thereby forming a coiled structure 216. Coils 214₁, 214₃, 214₅, 214₇ and 214₉ helically advance in a direction which points perpendicularly out of the drawing sheet. Coils 214₂, 214₄, 214₆ and 214₈, helically advance in a direction which points perpendicularly into the drawing sheet.

The portion of active optical fiber 206 between coils 214₁ and 214₂, is referenced 218_{1,2}. The portion of active optical fiber 206 between coils 214₂ and 214₃, is referenced 218_{2,3}. The portion of active optical fiber 206 between coils 214₄ and 214₅, is referenced 218_{4,5}. The portion of active optical fiber 206 between coils 214₆ and 214₇, is referenced 218_{6,7}. The portion of active optical fiber 206 between coils 214₇ and 214₈, is referenced 218_{7,8}. The portion of active optical fiber 206 between coils 214₈ and 214₉, is referenced 218_{8,9}. The two ends of active optical fiber 206 are referenced 220 and 222.

With reference to FIG. 2A, coils 200₁ and 200_{N} helically advance in a direction designated by an arrow 224. Coil 200₂ advances in a direction designated by an arrow 226. Coils 200₁, 200₂ and 200_{N} form a top annular face at an end 228 of coiled structure 202 and a bottom annular face (not shown) at another end 230 of coiled structure 202. Similarly, coils 214₁ (FIG. 2B), 214₂, 214₃, 214₄, 214₅, 214₆, 214₇, 214₈ and 214₉ form a top annular face and a bottom annular face (not shown). The distance between the top annular face and the bottom annular face of coiled structure 202 (FIG. 2A) is referenced H.

With reference to FIG. 2A, optical assembly 186 is located between light source 182 and entry surface 194. Optical assembly 188 is located between light source 184 and entry surface 196. Exit surface 198 is located adjacent to the top annular face. A light pumping region where exit surface 198 makes contact with coil 200₁ is referenced 232₁. A light pumping region where exit surface 198 makes contact with coil 200₂ is referenced 232₂. A light pumping region where exit surface 198 makes contact with coil 200_{N} is referenced 232_{N}. The outer cladding (not shown) of active optical fiber 192 in regions 232₁, 232₂ and 232_{N} is stripped off, thereby allowing exit surface 198 to make contact with the inner cladding (not shown) of coils 200₁, 200₂ and 200_{N}. The index of refraction of light introducer 190 is substantially equal to the index of refraction of the inner cladding of active optical fiber 192.

Light sources 182 and 184 together with optical assemblies 186 and 188 and light introducer 190, pump light into active optical fiber 192, in each of light pumping regions 232₁, 232₂ and 232_{N} of active optical fiber 192. Active optical fiber 192 is wound, such that the length of active optical fiber 192 between light pumping regions 232₁ and 232₂, is substantially equal to the absorption length of active optical fiber 192. Similarly, the length of active optical fiber 192 between light pumping regions 232₂ and 232_{N}, is substantially equal to the absorption length of active optical fiber 192. Thus, the distance between light pumping regions 232₁ and 232₂ along active optical fiber 192, is of the order of the absorption length of active optical fiber 192. Similarly, the distance between light pumping regions 232₂ and 232_{N} along active optical fiber 192, is of the order of the absorption length of active optical fiber 192. When light, at a certain wavelength is introduced into one end of the active fiber, this light may be amplified and will emerge from the other end of the active fiber. Thus, active optical fiber 192 operates as a light amplifier.

With reference to FIG. 2B, the exit surface (not shown) of light introducer 208 is located adjacent to the top annular face of coiled structure 216. Two light sources (not shown) similar to light sources 182 and 184 (FIG. 2A), pump light into active optical fiber 206, through two optical assemblies (not shown) similar to optical assemblies 186 and 188 and entry surfaces 210 and 212. Thus, the two light sources pump light into active optical fiber 206 through light pumping regions of active optical fiber 206, which are located side by side along a substantially flat plane. Active optical fiber 206 is wound such that the distance between every two consecutive light pumping regions, along the length of active optical fiber 206, is of the order of the absorption length of active optical fiber 206.

With reference to FIG. 2A, the number of coils 200₁, 200₂ and 200_{N} is limited and depends on the parameters of active optical fiber 192, light sources 182 and 184 and optical assemblies 186 and 188. These parameters include, for instance, the outer diameter D_{f} of active optical fiber 192, physical properties of active optical fiber 192, dimensions of each of light sources 182 and 184, magnification of each of optical assemblies 186, and 188 and the like. Height H of coiled structure 202 is substantially independent of the parameters of active optical fiber 192. Therefore, height H can be traded for a diameter D_{c} of coiled structure 202, while keeping the distance between every two adjacent light pumping regions (e.g., between light pumping regions 232₁ and 232₂ and between light pumping regions 232₂ and 232_{N}) along active optical fiber 192 substantially constant. Thus, by increasing height H, diameter D_{c} can be reduced, while keeping the distance between the consecutive light pumping regions substantially unchanged. In this manner, coiled structure 202 can be made substantially thinner and longer, while keeping the amount of pump light introduced into active optical fiber 192 at substantially the same power. It is further noted that other sets of light sources, optical assemblies and light introducers, can be located at other locations along the top annular surface of coiled structure 202, and at other locations along the bottom annular surface of coiled structure 202.

It is noted that the cross section of active optical fiber 192 can be in form of a polygon (e.g., square, rectangle, hexagon), or a contour which is defined by a combination of lines and curves (e.g., D-shape, as described herein above in connection with FIG. 1B, or rectangular D-shape). The term “rectangular D-shape” herein below, is referred to a modified rectangle or a square where one of the four sides of the rectangle or the square is replaced by a curve, such as an arc of a circle. This rectangular D-shape can be obtained for example, by milling a conventional round fiber perform along a cylindrical surface thereof, to introduce three plane surfaces along the cylindrical fiber perform. By employing an active optical fiber in the form of a rectangular D-shape, it is possible to pack the active optical fiber side-by-side in a compact form, substantially without any spaces. Moreover, the rectangular D-shaped contour of a double clad active optical fiber provides improved coupling of clad light to the core.

According to another aspect of the disclosed technique, a plurality of sections of different coils of a coiled active optical fiber are drawn out of the coiled boundaries of the active optical fiber and the sections are linearly aligned along a flat plane. The flat exit surface of the light introducer is placed along the flat plane and adjacent the sections, and light is pumped into the sections from a light source, through an optical assembly.

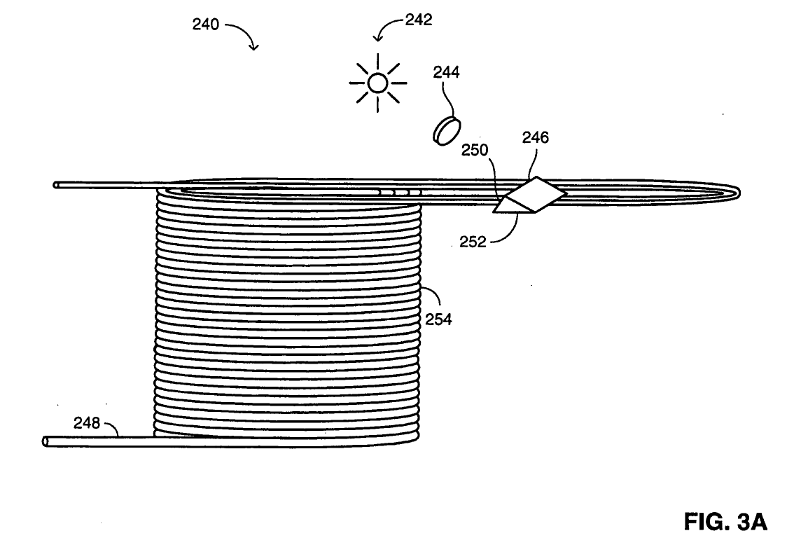

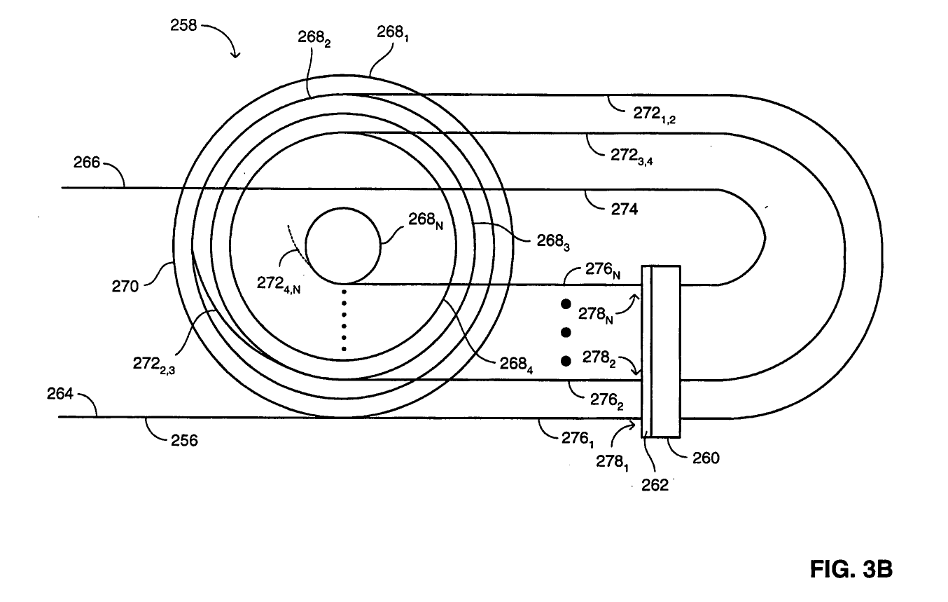

Reference is now made to FIGS. 3A and 3B. FIG. 3A is a schematic illustration of a light amplifier, generally referenced 240, constructed and operative in accordance with a further embodiment of the disclosed technique. FIG. 3B is a schematic illustration of a top view of a light amplifier 258, similar to the light amplifier of FIG. 3A.

Light amplifier 240 includes a light source 242, an optical assembly 244, a light introducer 246 and an active optical fiber 248. Light introducer 246 includes an entry surface 250 and an exit surface 252. Light source 242, optical assembly 244, light introducer 246 and active optical fiber 248 are similar to light source 102 (FIG. 1A), optical assembly 104, light introducer 106 and active optical fiber 112, respectively. Active optical fiber 248 is wound into a coiled structure 254. The winding of active optical fiber 248 is similar to that of an active optical fiber 256 (FIG. 3B) of light amplifier 258.

With reference to FIG. 3B, light amplifier 258 includes active optical fiber 256 and a light introducer 260. Light introducer 260 includes an entry surface 262 and an exit surface (not shown). Active optical fiber 256 and light introducer 260 are similar to active optical fiber 248 (FIG. 3A) and light introducer 246, respectively. The ends of active optical fiber 256 are referenced as 264 and 266. Active optical fiber 256 is wound into a plurality of coils 268₁, 268₂, 268₃, 268₄ and 268_{N}, thereby forming a coiled structure 270. Coils 268₁, 268₂, 268₃, 268₄ and 268_{N} are wound in a manner similar to coils 214₁ (FIG. 2B), 214₂, 214₃, 214₄, 214₅, 214₆, 214₇, 214₈ and 214₉. Thus, a diverting portion 272_{1,2} of active optical fiber 256 couples coils 268₁ and 268₂. Similarly, a diverting portion 272_{2,3} of active optical fiber 256 couples coils 268₂ and 268₃, a diverting portion 272_{3,4} of active optical fiber 256 couples coils 268₃ and 268₄ and a diverting portion 272_{4,N} of active optical fiber 256 couples coils 268₄ and 268_{N}.

The difference between the windings of active optical fiber 206 (FIG. 2A) and active optical fiber 256 (FIG. 3B), is that diverting portions 272_{1,2}, 272_{3,4} and a diverting portion 274 of coil 268_{N} are placed outside the region confined by coiled structure 270. Furthermore, diverting portions 272_{1,2}, 272_{3,4} and 274 are arranged, such that a section 276₁ of diverting portion 272_{1,2}, a section 276₂ of diverting portion 272_{3,4} and a section 276_{N} of diverting portion 274, are linearly aligned side by side along a flat plane (not shown).

It is noted that any single diverting portion can be formed between any two coils which are not necessarily in a consecutive order. Thus, for example, a diverting portion can be formed between coils 268₁ and 268₄.

The exit surface of light introducer 260 is placed adjacent to sections 276₁, 276₂ and 276_{N}. A light pumping region at which the exit surface makes contact with section 276₁ is referenced 278₁. Similarly, light pumping regions at which the exit surface makes contact with sections 276₂ and 276_{N}, are referenced 278₂ and 278_{N}, respectively. Active optical fiber 256 is wound such that the distance between every two consecutive light pumping regions, such as light pumping regions 276₁ and 276₂ along active optical fiber 256 is substantially equal to the absorption length of active optical fiber 256.

It is noted that additional diverting portions of the same coil can protrude from the coiled structure, at different heights of the coiled structure. Thus, at each height along the longitudinal axis of the coiled structure, a plurality of diverting portions from different coils protrude from the coiled structure.

The sections of each of these new diverting portions at each of the heights, can be linearly arranged side by side along another flat plane (not shown) and another light introducer similar to light introducer 246 (FIG. 3A) can be placed adjacent to these new sections. Light can be pumped into the active optical fiber at these new light pumping regions, by employing a light source similar to light source 242 and an optical assembly similar to optical assembly 244. The active optical fiber is wound in such a manner, that the distance between every two consecutive light pumping regions of these new diverting portions along the active optical fiber, is substantially equal to the absorption length of the active optical fiber.

Different combinations of light introducers, optical assemblies and light sources can be employed to pump light into the active optical fiber, at different heights thereof. For example, a plurality of optical sets, each optical set including a light introducer and an optical assembly, can be employed to pump light into the sections of each of the diverting portions at each of the heights, while employing the same light source to pump light into all the sections. Alternatively, all sections of all the diverting portions at different heights may be arranged linearly in the same flat plane and the same light introducer, optical assembly and light source may be employed to pump light into the active optical fiber. Further alternatively, one optical assembly can be employed to direct light at the entry surfaces of a plurality of light introducers. Alternatively, light can be introduced into the fiber at each light pumping region, by employing a light introducer similar to light introducer 190 (FIG. 2A), optical assemblies similar to optical assemblies 186 and 188 and light sources similar to light sources 182 and 184.

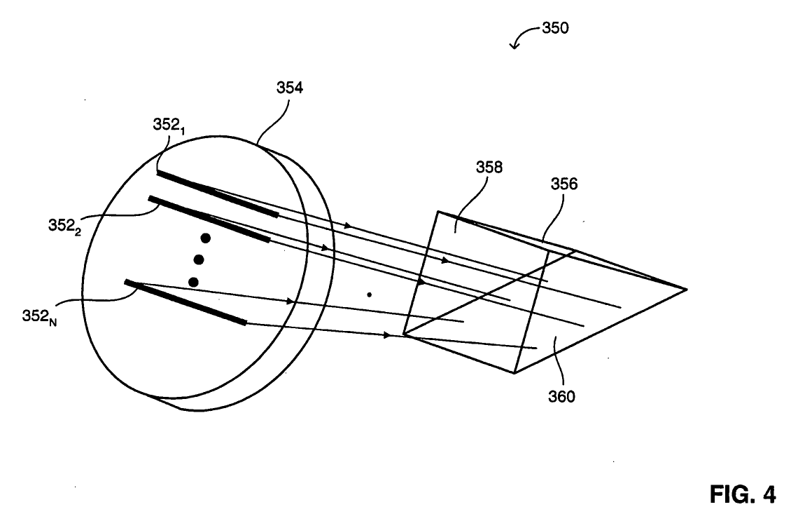

Reference is now made to FIG. 4, which is a schematic illustration of a light focusing assembly, generally referenced 350, constructed and operative in accordance with another embodiment of the disclosed technique. Light focusing assembly 350 includes a plurality of laser diode stripes 352₁, 352₂ and 352_{N} (i.e. a laser diode stack), an optical assembly 354 and a light introducer 356. Light introducer 356 includes an entry surface 358 and an exit surface 360. Optical assembly 354 and light introducer 356 are similar to optical assembly 104 (FIG. 1A) and light introducer 106, respectively.

Optical assembly 354 is located between laser diode stripes 352₁, 352₂ and 352_{N} and entry surface 358. Optical assembly 354 directs the light emitted by laser diode stripes 352₁, 352₂ and 352_{N} toward a plurality of inner claddings (not shown), which are optically coupled with exit surface 360. As in the light amplifier 100 of 1A, it is essential that all those light rays have angles relative to the fiber axis such that they will be guided by the inner claddings.

Optical assembly 354 directs the light from laser diode stripes 352₁, 352₂ and 352_{N} toward the inner cladding, thereby forming a complete image (not shown) of laser diode stripes 352₁, 352₂ and 352_{N} which is partly located within the inner cladding and partly located external thereof. The external portion of this image (not shown) is located on the side of the inner cladding opposite that of exit surface 360 (not shown). The light which forms the image external to the inner cladding, totally reflects from the side of the inner cladding opposite that of exit surface 360 and forms a real image (not shown) of laser diode stripes 352₁, 352₂ and 352_{N} within the inner cladding. This real image is substantially smaller than the complete image and optical assembly 354 is constructed such that the real image is entirely confined within the inner cladding.

It is noted that the optical assembly can include refractive elements (e.g., lenses), reflective elements (e.g., mirrors), a combination thereof, and the like. It is further noted that the pump light can be concentrated into the inner cladding by imaging or non-imaging optical techniques.

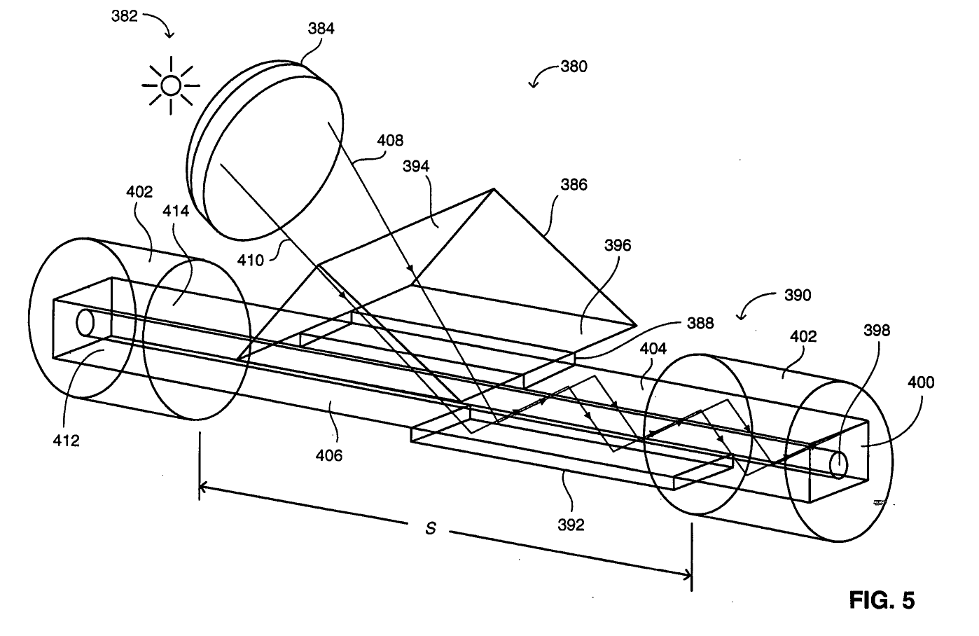

Reference is now made to FIG. 5 which is a schematic illustration of a section of a light amplifier, generally referenced 380, constructed and operative in accordance with a further embodiment of the disclosed technique. Light amplifier 380 includes a light source 382, an optical assembly 384, a light introducer 386, an optical mediator 388, an active optical fiber 390 and a reflector 392. Light introducer 386 includes an entry surface 394 and an exit surface 396. Active optical fiber 390 includes a core 398, an inner cladding 400 and an outer cladding 402. Inner cladding 400 includes a top surface 404 and a bottom surface 406.

Light source 382, optical assembly 384, light introducer 386 and core 398 are similar to light source 102 (FIG. 1A), optical assembly 104, light introducer 106 and core 124, respectively. Inner cladding 400 is similar to either inner cladding 114 (FIG. 1A) or inner cladding 154 (FIG. 1B). A section S of outer cladding 402 is removed, thereby exposing top surface 404 and bottom surface 406 of inner cladding 400. The region of top surface 404 outside of optical mediator 388, is surrounded by a substance, such as air, vacuum, and the like, whose index of refraction is substantially smaller than that of inner cladding 400. The refractive index of outer cladding 402 is substantially smaller than that of inner cladding 400.

Optical mediator 388 is a thin layer of liquid, fluid, gel, solid material, and the like, whose refractive index is substantially equal to that of light introducer 386 and inner cladding 400. If optical mediator 388 is in form of an adhesive, then exit surface 396 is fastened to top surface 404 by optical mediator 388. If optical mediator 388 is in form of a thin solid layer, then optical mediator 388 is placed between exit surface 396 and top surface 404. Moreover, optical mediator 388 has a substantially low light absorption, a substantially high thermal conductivity, a substantially low coefficient of thermal expansion, the refractive index thereof is substantially invariable at different temperatures, and the physical properties thereof remain substantially constant as the ambient temperature is raised. The thickness of optical mediator 388 is kept at a minimal level, in order to reduce light absorption, to reduce the amount of heat generated in the optical mediator 388 and to reduce the temperature thereof. Optical mediator 388 can be in form of a glass solder. By employing a rectangular D-shaped active optical fiber, thanks to tight packaging, it is possible to use a smaller optical mediator than in the case of a conventional round cross section fiber.

Reflector 392 is in form of a reflective coating of Aluminum, Silver, Chromium, dielectric coating, multi-layer interference coating, and the like, which is applied to bottom surface 406. Alternatively, reflector 392 is in form of a thin layer of a reflective material, such as Aluminum, Silver, Chromium, and the like, or dielectric material, which is fastened to bottom surface 406. Optical assembly 384 is located between light source 382 and entry surface 394. Optical assembly 384 directs light beams 408 and 410 from light source 382 toward entry surface 394. Since the refractive index of light introducer 386, optical mediator 388 and inner cladding 400 are substantially the same, light beams 408 and 410 pass from light introducer 386 to bottom surface 406, through optical mediator 388 with no deflections and minimal losses.

Reflector 392 directs light beams 408 and 410 from bottom surface 406 to top surface 404 at locations along inner cladding 400, where neither light introducer 386 nor optical mediator 388 contact inner cladding 400. The index of refraction of the substance which surrounds the region of top surface 404 outside of optical mediator 388, is less than the index of refraction of inner cladding 400, whereby top surface 404 reflects light beams 408 and 410 toward bottom surface 406. Reflector 392 directs light beams 408 and 410 toward a region of inner cladding 400, which is surrounded by outer cladding 402. Since the index of refraction of outer cladding 402 is smaller than that of inner cladding 400, top surface 404 directs light beams 408 and 410 toward bottom surface 406.

Since outer cladding 402 surrounds inner cladding 400 at all regions of active optical fiber 390 except section S, light beams 408 and 410 are repeatedly totally reflected between top surface 404 and bottom surface 406. In this manner, light beams 408 and 410 propagate along inner cladding 400, while some of the time passing through core 398. It is noted that light beams 408 and 410 are repeatedly totally reflected from top surface 404 and bottom surface 406, as well as from side surfaces 412 and 414 of inner cladding 400.

It is further noted that light beams 408 and 410 which reflect from bottom surface 406 to top surface 404, strike top surface 404 outside exit surface 396. This is possible, by providing light introducer 386 with a selected geometry and by introducing light beams 408 and 410 into inner cladding 400, such that the angle between light beams 408 and 410 and the normal to longitudinal axis (not shown) of inner cladding 400, is greater than the critical angle. Otherwise, light beams 408 and 410 would exit inner cladding 400 through exit surface 396 and would not repeatedly totally reflect between bottom surface 406, top surface 404 and side surfaces 412 and 414.

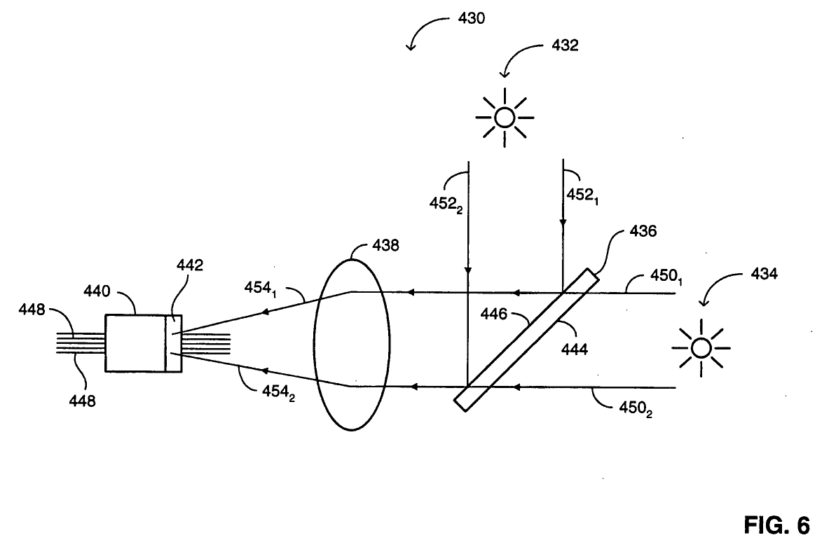

Reference is now made to FIG. 6, which is a schematic illustration of a top view of a light focusing assembly, generally referenced 430, constructed and operative in accordance with another embodiment of the disclosed technique. Light focusing assembly 430 includes light sources 432 and 434, a beam splitter 436, an optical assembly 438 and a light introducer 440. Light introducer 440 includes an entry surface 442 and an exit surface (not shown). The exit surface is substantially flat. Optical assembly 438 and light introducer 440 are similar to optical assembly 104 (FIG. 1A) and light introducer 106, respectively. Each of light sources 432 and 434 is similar to light source 102. However, light sources 432 and 434 are of different optical characteristics, such as wavelength, polarization and the like. Beam splitter 436 is an optical element which partly transmits and partly reflects the incident light, depending on the optical characteristic of the incident light.

Optical assembly 438 is located between entry surface 442 and beam splitter 436. Beam splitter 436 is located between light source 434 and optical assembly 438, such that light source 434 points toward a face 444 of beam splitter 436. Beam splitter 436 is tilted by approximately 45 degrees from the line of sight of light source 434 and optical assembly 438. Light source 432 points toward another face 446 of beam splitter 436 and face 446 points toward optical assembly 438. The exit surface of light introducer 440 is located above a plurality of sections 448 of an active optical fiber (not shown). Each of sections 448 is similar to sections 318₁, 318₂ and 318_{N} (FIG. 4) and sections 448 are linearly aligned along a flat surface (not shown) below the exit surface of light introducer 440, in a manner similar to that illustrated in FIG. 4.

Beam splitter 436 transmits light beams 450₁ and 450₂ from light source 434 toward optical assembly 438. Beam splitter 436 reflects light beams 452₁ and 452₂ from light source 432 toward optical assembly 438. Optical assembly 438 directs transmitted light beams 450₁ and 450₂ and reflected light beams 452₁ and 452₂ toward entry surface 442, as combined light beams 454₁ and 454₂. It is noted that the power of combined light beams 454₁ and 454₂ is equal to the sum of transmitted light beams 450₁ and 450₂ and reflected light beams 452₁ and 452₂.

Light introducer 440 directs combined light beams 454₁ and 454₂ toward sections 448. Thus, light focusing assembly 430 focuses light from two light sources toward a plurality of sections of an active optical fiber.

It is noted that if the cross section of the light introducer is trapezoidal, thus having two entry surfaces, then light can be pumped into the fiber sections through both of the entry surfaces, traveling in the fibers in generally opposed directions. In this case, a set of light sources, beam splitter and optical assembly, similar to light sources 432 and 434, beam splitter 436 and optical assembly 438, respectively, and arranged in the same manner, is placed at each of the two entry surfaces. Thus, light is introduced into the sections of the active optical fiber, from four different light sources.

It is noted that light from additional light sources may be introduced into the active optical fiber at the same sections. For example, light beams 452₁ and 452₂ may be provided from another beam splitter that serves to add light beams from two individual sources, and so forth.

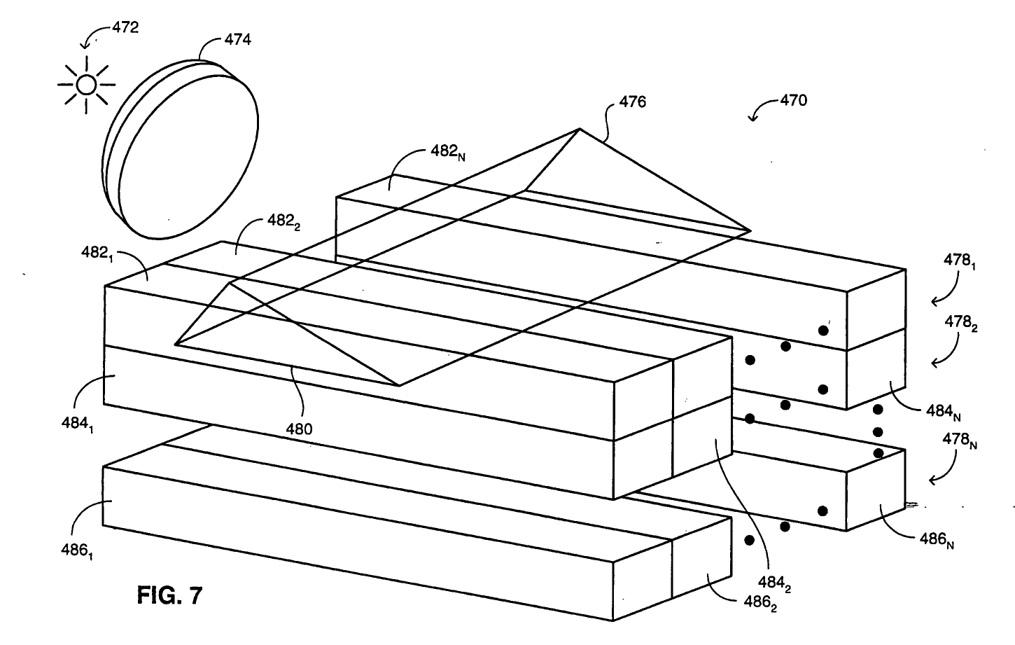

Reference is now made to FIG. 7, which is a schematic illustration of a light amplifier, generally referenced 470, constructed and operative in accordance with a further embodiment of the disclosed technique. Light amplifier 470 includes a light source 472, an optical assembly 474, a light introducer 476 and a plurality of fiber section layers 478₁, 478₂ and 478_{N}. Light introducer 476 includes an exit surface 480. Light source 472, optical assembly 474 and light introducer 476 are similar to light source 102 (FIG. 1A), optical assembly 104 and light introducer 106, respectively.

Fiber section layer 478₁ includes a plurality of fiber sections 482₁, 482₂ and 482_{N}. Fiber section layer 478₂ includes a plurality of fiber sections 484₁, 484₂ and 484_{N}. Fiber section layer 478_{N} includes a plurality of fiber sections 486₁, 486₂ and 486_{N}. Each of fiber sections 482₁, 482₂, 482_{N}, 484₁, 484₂, 484_{N}, 486₁, 486₂ and 486_{N} is part of the same active optical fiber (not shown), similar to active optical fiber 112₁ (FIG. 1A). Fiber sections 482₁, 482₂, 482_{N}, 484₁, 484₂, 484_{N}, 486₁, 486₂ and 486_{N} are arranged such that the distance between every two consecutive sections along the length of the active optical fiber, is of the order of the absorption length of the active optical fiber.

Fiber sections 482₁, 482₂ and 482_{N} are closely packed and aligned along a substantially flat plane (not shown) defined by exit surface 480 and are optically coupled with exit surface 480. Fiber sections 484₁, 484₂ and 484_{N} are closely packed and aligned along another substantially flat plane, substantially parallel with that of exit surface 480. Fiber sections 486₁, 486₂ and 486_{N} are closely packed and aligned along another substantially flat plane, substantially parallel with that of exit surface 480.

Fiber section layer 478₁ is optically coupled with exit surface 480 and with fiber section layer 478₂ and fiber section layer 478_{N} is optically coupled with fiber section layer 478₂. Since fiber sections 482₁, 482₂, 482_{N}, 484₁, 484₂, 484_{N}, 486₁, 486₂ and 486_{N} (i.e., inner claddings) are part of the same active optical fiber, the indices of refraction thereof are substantially equal. Thus, light which enters fiber sections 482₁, 482₂ and 482_{N} through exit surface 480, enters fiber sections 484₁, 484₂ and 484_{N}, respectively, through the opposite sides of fiber sections 482₁, 482₂ and 482_{N}. This light enters the other fiber section layers (not shown) after exiting fiber sections 484₁, 484₂ and 484_{N} and enters fiber sections 486₁, 486₂ and 486_{N}, respectively.

The sides of fiber sections 486₁, 486₂ and 486_{N} opposite to the sides at which light entered fiber sections 486₁, 486₂ and 486_{N} are exposed to a medium, such as air, vacuum, and the like, whose index of refraction is less than that of fiber sections 486₁, 486₂ and 486_{N}. Thus, the light reflects from fiber sections 486₁, 486₂ and 486_{N}, passes through fiber sections 484₁, 484₂, 484_{N}, 482₁, 482₂ and 482_{N}, and reflects from the sides of fiber sections 482₁, 482₂ and 482_{N}, which are located away from exit surface 480.

In this manner, light repeatedly passes through the core (not shown) of the active optical fiber, wherein it is amplified. It is noted that by arranging the active optical fiber in parallel layers 478₁, 478₂ and 478_{N}, it is possible to form a substantially large image of light source 472 within fiber section layers 478₁, 478₂ and 478_{N}.

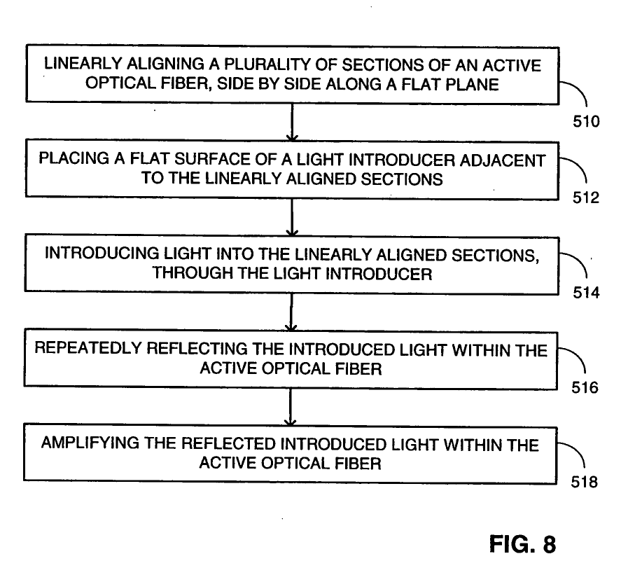

Reference is now made to FIG. 8, which is a schematic illustration of a method for operating the light amplifier of FIGS. 1A, operative in accordance with another embodiment of the disclosed technique. In procedure 510, a plurality of sections of an active optical fiber are linearly aligned side by side along a flat plane. With reference to FIG. 1A, respective inner cladding sections of active optical fibers 112₁, 112₂ and 112_{N}, are linearly aligned side by side along the substantially flat plane of exit surface 110.

In procedure 512, a flat surface of a light introducer is placed adjacent to the linearly aligned sections. With reference to FIG. 1A, exit surface 110 of light introducer 106 is placed on active optical fibers 112₁, 112₂ and 112_{N}.

In procedure 514, light is introduced into the linearly aligned sections, through the light introducer. With reference to FIG. 1A, optical assembly 104 directs light beams 116 and 118 from light source 102 to bottom surface 122 of inner cladding 114, through light introducer 106.

In procedure 516, the introduced light is repeatedly reflected within the active optical fiber. With reference to FIG. 1A, light beams 116 and 118 are repeatedly reflected between bottom surface 122, top surface 120 and side surfaces 160 and 162, wherein light beams 116 and 118 propagate within active optical fiber 112.

In procedure 518, light is amplified within the active optical fiber. With reference to FIG. 1A, as light beams 116 and 118 repeatedly reflect between bottom surface 122, top surface 120 and side surfaces 160 and 162, light beams 116 and 118 enter core 124. When light beams 116 and 118 strike the active constituents which are doped into core 124, these active constituents are excited and thereby amplify light at predetermined wavelengths. With reference to FIG. 2A, the amplified light emerges from ends 234 and 236 of active optical fiber 192.

It will be appreciated by persons skilled in the art that the disclosed technique is not limited to what has been particularly shown and described hereinabove. Rather the scope of the disclosed technique is defined only by the claims, which follow.

1. Light amplifier comprising:
an active optical fiber, arranged such that a plurality of fiber sections thereof are aligned and closely packed along a substantially flat plane, thereby defining a light pumping region; and
at least one light introducer having at least one entry surface and a substantially flat exit surface, said substantially flat exit surface being coupled with said light pumping region,
wherein pump light enters said active optical fiber at said light pumping region, through said at least one light introducer, and
wherein said light amplifier amplifies a light signal by exciting the active constituents of said active optical fiber.

2. The light amplifier according to claim 1, wherein said active optical fiber is wound in a plurality of coils having a mutual longitudinal axis,
wherein each of said coils is located within others of said coils,
wherein the height of said coils are substantially equal, and
wherein annular faces of said coils are located on said substantially flat plane.

3. The light amplifier according to claim 1, wherein a plurality of light pumping regions of said active optical fiber are arranged along a plurality of substantially flat planes, substantially parallel with said substantially flat exit surface,
wherein said light pumping regions are arranged in a direction substantially normal to said substantially flat exit surface, and
wherein said light pumping regions are optically coupled there between.

4. The light amplifier according to claim 1, wherein the distance between every two consecutive light pumping regions along the length of said active optical fiber, is of the order of the absorption length of said active optical fiber.

5. The light amplifier according to claim 2, wherein said active optical fiber is wound such that at least one diverting portion of at least one of said coils, protrudes from a region confined by said coils, at at least one predetermined location along the linear length of a respective one of said at least one of said coils, and
wherein selected ones of said fiber sections at at least one of said at least one diverting portion, are linearly aligned along at least one substantially flat plane.

6. The light amplifier according to claim 5, wherein the distance between every two consecutive fiber sections along the length of said active optical fiber, where pump light enters said active optical fiber, is of the order of the absorption length of said active optical fiber.

7. The light amplifier according to claim 1, wherein said active optical fiber includes:
a core; and
a first cladding surrounding said core, said first cladding having a flat surface located between said exit surface and said core.

8. The light amplifier according to claim 7, wherein said light amplifier produces said amplified light signal, by repeatedly reflecting said pump light between said flat surface and other surfaces of said first cladding, and by repeatedly exciting said active constituents.

9. The light amplifier according to claim 7, wherein the refractive indices of said light introducer and said first cladding are substantially equal.

10. The light amplifier according to claim 7, wherein said light amplifier further comprises an optical mediator located between said exit surface and said flat surface.

11. The light amplifier according to claim 10, wherein the refractive indices of said light introducer, said optical mediator and said first cladding are substantially equal.

12. The light amplifier according to claim 8, wherein said light amplifier further comprises a reflective layer located on at least one of said other surfaces, said reflective layer reflecting said light between said flat surface and said other surfaces.

13. The light amplifier according to claim 7, wherein the cross section of said first cladding is selected from the list consisting of:
square;
rectangular;
hexagon;
D-shaped;
rectangular D-shaped; and
A closed shape which includes at least one linear segment.

14. The light amplifier according to claim 1, wherein the optical power of said at least one entry surface is different from zero.

15. The light amplifier according to claim 7, wherein said active optical fiber further includes a second cladding surrounding said first cladding,
wherein the index of refraction of said second cladding is less than the index of refraction of said first cladding, and
wherein at least a portion of said second cladding at each of said fiber sections is removed from said active optical fiber.

16. The light amplifier according to claim 1, wherein said light amplifier further comprises at least one light source in form of a laser diode stripe.

17. The light amplifier according to claim 16, wherein said light amplifier further comprises at least one optical assembly located between said at least one light source and said at least one entry surface, and
wherein said optical assembly focuses said at least one light source at said light pumping region.

18. The light amplifier according to claim 1, wherein said light amplifier further comprises:
a first light source;
a second light source; and
a beam splitter located between said first light source and said entry surface,
wherein said beam splitter is tilted by approximately 45 degrees from the line of sight of said first light source and said entry surface,
wherein said first light source points toward a first face of said beam splitter, and
wherein said second light source and said entry surface point toward a second face of said beam splitter, opposite to said first face.

19. The light amplifier according to claim 18, wherein said light amplifier further comprises an optical assembly located between said entry surface and said beam splitter.

20. Method for amplifying light, the method comprising the procedures of:
linearly aligning a plurality of fiber sections of an active optical fiber, side by side, along a substantially flat plane;
placing a flat surface of a light introducer adjacent to said fiber sections;
repeatedly reflecting light within said active optical fiber; and
amplifying said light within said active optical fiber.

21. The method according to claim 20, further comprising a procedure of introducing said light into said fiber sections, through said light introducer, after said procedure of placing.

22. The method according to claim 20, further comprising a preliminary procedure of removing at least a portion of an outer cladding of said active optical fiber in the region of said fiber sections.

23. The method according to claim 20, further comprising a preliminary procedure of placing an optical mediator between said flat surface and an inner cladding of said active optical fiber.

24. The method according to claim 20, further comprising a preliminary procedure of coupling a reflective layer with an inner cladding of said active optical fiber,
wherein said inner cladding is located between said reflective layer and said flat surface.

25. The method according to claim 20, further comprising a preliminary procedure of winding said active optical fiber in a plurality of coils having a mutual longitudinal axis,
wherein each of said coils is located within others of said coils,
wherein the height of said coils are substantially equal, and
wherein annular surfaces of said coils are located at said substantially flat plane.

26. The method according to claim 25, further comprising a procedure of winding said active optical fiber, such that at least a diverting portion of at least one of said coils, protrudes from a region confined by said coils, at at least one predetermined location along the linear length of a respective one of said at least one of said coils, and
wherein selected ones of said fiber sections at at least one of said at least one diverting portion, are linearly aligned along at least one substantially flat plane.

27. The method according to claim 20, further comprising a preliminary procedure of doping a core of said active optical fiber, with active constituents which amplify optical radiation, when said active constituents are excited by said light.

28. The method according to claim 20, further comprising a procedure of producing an image of at least one light source at said fiber sections within an inner cladding of said active optical fiber, after said procedure of placing.

29. Laser cavity comprising:
an active optical fiber, arranged such that a plurality of fiber sections thereof are aligned and closely packed along a substantially flat plane, thereby defining a light pumping region; and
at least one light introducer having at least one entry surface and a substantially flat exit surface, said substantially flat exit surface being coupled with said light pumping region,
wherein pump light enters said active optical fiber at said light pumping region, through said at least one light introducer, and
wherein said laser cavity repeatedly amplifies light by repeatedly directing said light through said optical fiber.

30. The laser cavity according to claim 29, wherein said laser cavity is a linear laser cavity.

31. The laser cavity according to claim 29, wherein said laser cavity is a laser ring cavity.

32. Method for producing laser radiation, the method comprising the procedures of:
linearly aligning a plurality of fiber sections of an active optical fiber, side by side, along a substantially flat plane;
placing a flat surface of a light introducer adjacent to said fiber sections;
repeatedly reflecting pump light within said active optical fiber; and
repeatedly directing a light signal through said optical fiber, thereby repeatedly amplifying said light signal.
